(19) United States
(12) Patent Application Publication
(10) Pub. No.: US 2024/0383098 A1
(43) Pub. Date: Nov. 21, 2024

(54) MACHINE FOR PROCESSING SHEET METAL PARTS

(71) Applicant: ARKU MASCHINENBAU GMBH, Baden-Baden (DE)

(72) Inventors: Jacques BURTSCHER, Roeschwoog (FR); Gerald KHIM, Waghäusel (DE)

(73) Assignee: ARKU MASCHINENBAU GMBH, Baden-Baden (DE)

(21) Appl. No.: 18/696,791

(22) PCT Filed: Apr. 7, 2022
(86) PCT No.: PCT/EP2022/059305

§ 371 Date: Mar. 28, 2024

(30) Foreign Application Priority Data
Oct. 1, 2021 (DE) 10 2021 125 496.5

(51) Int. Cl. B24B 51/00; B24B 29/00

(52) U.S. Cl. CPC B24B 51/00; B24B 29/005

(57) ABSTRACT

A machine for processing sheet metal parts includes a brush unit having at least one horizontally rotating abrasive brush for brushing the surface of the sheet metal parts to be processed. In order to adjust the processing gap or the infeed, the brush unit is movable in the vertical direction. A measuring device for measuring the diameter of the freely turning abrasive brush at different speeds may be designed as an optical measuring unit, in particular a light barrier. A calibration device is used to calculate the correct vertical position of the abrasive brush depending on a selected speed and the associated diameter of the abrasive brush.

The present invention relates to a machine for processing sheet metal parts, in particular for deburring, rounding edges, and grinding the surface. The invention further relates to a method and a corresponding device for calibrating and adjusting such a machine.

When cutting and punching parts from sheet steel, disruptive burrs, which protrude on the upper side and underside, form on the cut edges and the edges of holes and recesses. Particularly in the case of parts, which are manufactured from sheet steel that is several centimeters thick, greater technical effort is required to deburr the same, to round the edges, and to grind the surface flat.

DE 20 2020 107 308 U1 describes a machine with three linked processing units, which are arranged one behind the other conveyor belt along a continuous in the throughput direction of the workpiece. The central processing unit is a brush unit with a total of eight abrasive brushes, four of which rotate in the running direction and four in the opposite direction around horizontal axes. An electric drive unit drives the abrasive brushes via a transfer case. While the drive unit is suspended in a fixed manner in the machine frame, the transfer case may be rotated about its vertical axis. The abrasive brushes comprise a plurality of flexible abrasive strips, whose ends brush over the surface of the sheet metal part being guided under the abrasive brushes and may thereby also penetrate a certain distance into recesses. At the same time, both the front and the interior edges of the sheet metal part are rounded.

Such a grinding and deburring machine must be precisely adjusted to the thickness of the sheet metal parts to be processed. The brushes have to act on the workpiece with a sufficiently high pressure, yet the rapidly rotating brush is not to be damaged or even snag on the workpiece. The abrasive brushes are indeed flexible and may deflect from the workpiece to a certain extent or yield to the processing pressure. Nonetheless, the processing gap, that is the distance between the abrasive brushes and the conveyor belt on which the sheet metal part rests, must be adjusted very precisely before the processing begins. The distance between the sheet metal surface and the brush is designated as the infeed.

Quickly rotating abrasive brushes with elastic bristles, for example, in the form of flexible abrasive strips, are subject to a great deal of wear when sharp burrs and edges of workpieces made from hard steel are abrasively processed with them. In particular, abrasive brushes in the form of cylindrical abrasive drums with a plurality of grinding strips, made from sandpaper or abrasive cloths, protruding radially outward, already wear out so severely after a relatively short operating time that they lose a substantial part of their diameter.

Another problem when adjusting the processing gap is that the individual bristles stand up due to centrifugal force as the speed increases, so that the diameter of the rotating abrasive brush increases, in particular at higher speeds. The processing gap therefore dynamically decreases, the forces from the workpiece acting on the abrasive brushes increase sharply, which increases wear.

The underlying technical problem of the invention is adjusting a sheet metal processing machine comprising rotating abrasive brushes correctly to the thickness of the sheet metal part to be processed, regardless of wear and speed.

The problem is solved by a machine with the features of the first patent claim.

The invention further relates to a method for calibrating such a sheet metal processing machine and a corresponding calibration and adjustment device.

The machine according to the invention comprises a measuring device for detecting the diameter of the abrasive brush when this rotates freely, that is, it is not pressed on a sheet metal part to be processed. The measurement of the diameter is carried out at different speeds. As a result, the actual state of the abrasive brush is precisely detected, indeed regardless of how much the diameter has already been reduced due to wear. If the diameter of the abrasive brush is not constant, but instead increases at higher speeds due to deformation due to the centrifugal forces acting on it, then this dynamic increase in diameter is likewise detected.

During the adjustment of the sheet metal part to be processed, in particular its thickness, a calibration device calculates the correct vertical position of the abrasive brush depending on a selected speed and the diameter previously detected by the measuring device, which is associated with the selected speed. A compensation for wear is thus carried out and a correction for speed-dependent changes in the diameter. The adjustment of the machine is carried out adaptively and always correctly, regardless of the type of abrasive brush used and its degree of wear.

The detecting of the diameter of the freely rotating abrasive brush may be carried out without contact, preferably using an optical measuring unit. Several measurements at different speeds are thus possible without any problems.

A light barrier is particularly preferably used as the measuring device, whose light beam is interrupted by the abrasive brush whose diameter is to be detected when the brush unit is moved downward. As the vertical position of the axis of rotation or the center point of the rotating abrasive brush is not dependent on wear or speed, a single light barrier is sufficient for scanning the diameter. When the laser beam of the light barrier is interrupted for the first time during the slow lowering of the brush unit, the instantaneous diameter of the abrasive brush may be calculated very easily from the vertical position of the brush unit or the axis of rotation of the abrasive brush. The measurement is subsequently repeated at other speeds in order to detect the relationship between speed and diameter in this way. The actual diameter of the abrasive brush is detected in each case, regardless of the degree of wear of the abrasive brush. The degree of wear may be determined by comparing the measurements with a reference measurement for a new abrasive brush without wear.

In the case of a brush unit that has multiple rotating abrasive brushes and is rotatable about its vertical axis, one complete revolution of the brush unit about its vertical axis is sufficient so that all, or at least the majority, of the abrasive brushes are detected by the light barrier one after the other, in order to scan the diameter without contact.

The problem is also solved by a method according to patent claim 5. The diameter of at least one abrasive brush is thereby detected at different speeds at a freely rotating abrasive brush without contact with a workpiece or the conveyor belt with which the workpiece is transported through the machine. In order to adjust the processing gap, that is, the correct infeed, based on a selected speed at which the abrasive brush is supposed to rotate, the previously detected diameter of the freely rotating abrasive brush at the corresponding speed is calculated and then the brush unit is moved vertically downwards in the direction of the conveyor belt or the workpiece until the calculated vertical position relative to the conveyor belt or the upper side of the sheet metal part is reached.

In a preferred embodiment of the method according to the invention, the diameters of the freely rotating abrasive brush or brushes is/are measured at the beginning of the calibration process and the associated speeds are stored so that the stored pairs of values may be accessed for the subsequent calculation and adjustment of the working gap. If the speed, automatically specified by the user and/or the machine and at which the workpiece is to be processed, does not correspond to any of the stored speeds, the approximate diameter for the selected speed may be calculated by interpolation.

Patent claim 8 defines a device for carrying out the method according to the invention. The device comprises an input interface for receiving measurement data from a measuring device, which detects the diameter of the freely rotating abrasive brush at different speeds, a memory unit for storing the detected diameters and the associated speeds, and a calibration device for calculating the vertical position of the brush unit over the sheet metal part that is to be processed, depending on a selected speed and the associated stored diameter, which was previously determined on the freely rotating abrasive brush. If necessary, intermediate values may be calculated by interpolation from the stored progression of the diameter over the speed. It has been shown that knowledge of three diameters, detected at different speeds, suffices for a sufficiently accurate calibration and adjustment. The accuracy and precision naturally increase with the number of pairs of values for speed and diameter.

Further aspects of the invention relate to a computer program product with program code for carrying out the calibration method according to the invention when the program code is executed on a computer. Also to be protected is a memory medium, on which a computer program is stored which, when executed on a computer, causes the described method to be carried out.

One embodiment of the invention is subsequently explained with reference to the attached figures. As shown in:

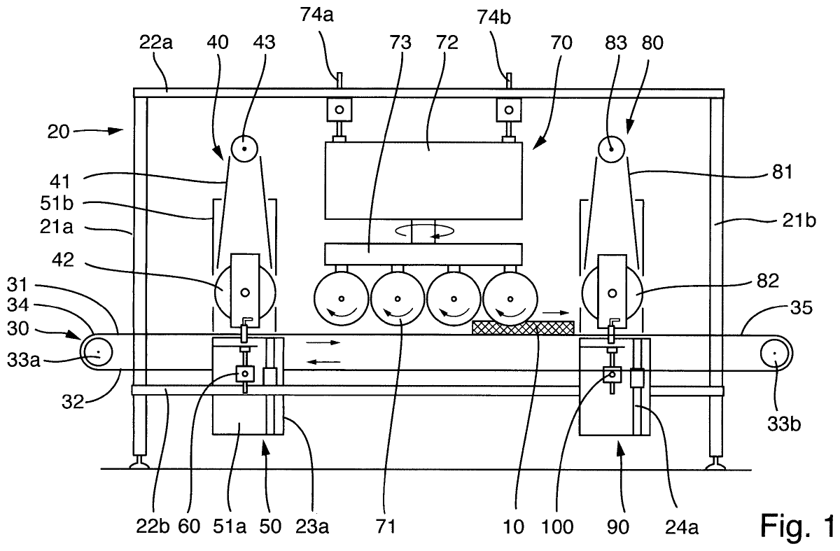

FIG. 1 a machine for processing sheet metal parts, in a simplified depiction from the side;

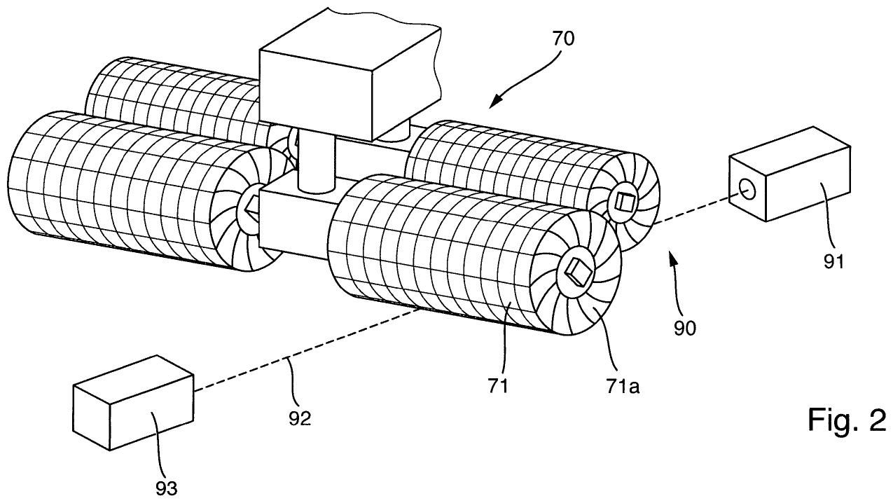

FIG. 2 a brush unit with rotating abrasive brushes and a light barrier, in a greatly simplified perspective depiction;

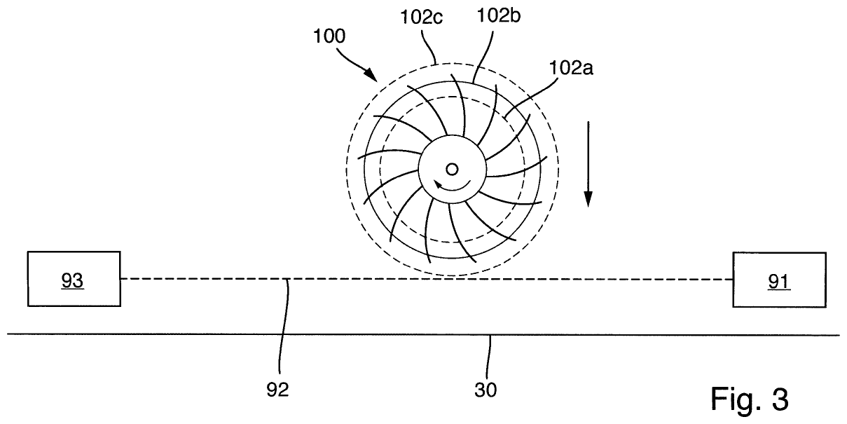

FIG. 3 an abrasive brush and the light barrier from FIG. 2, from the side;

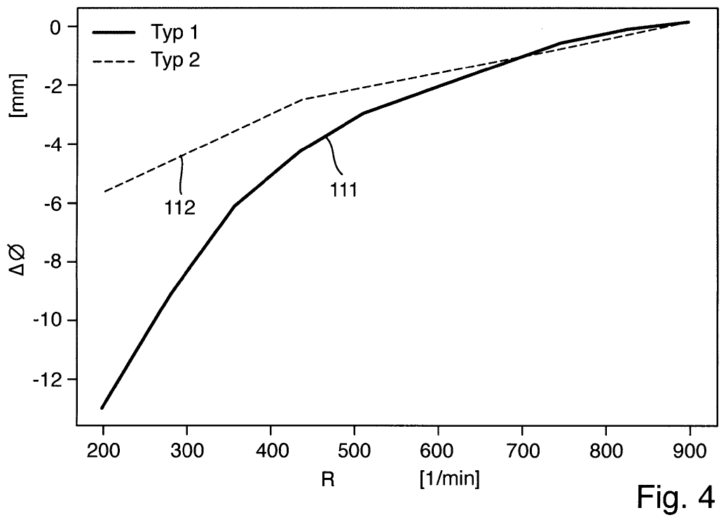

FIG. 4 the progression of the diameter depending on the speed;

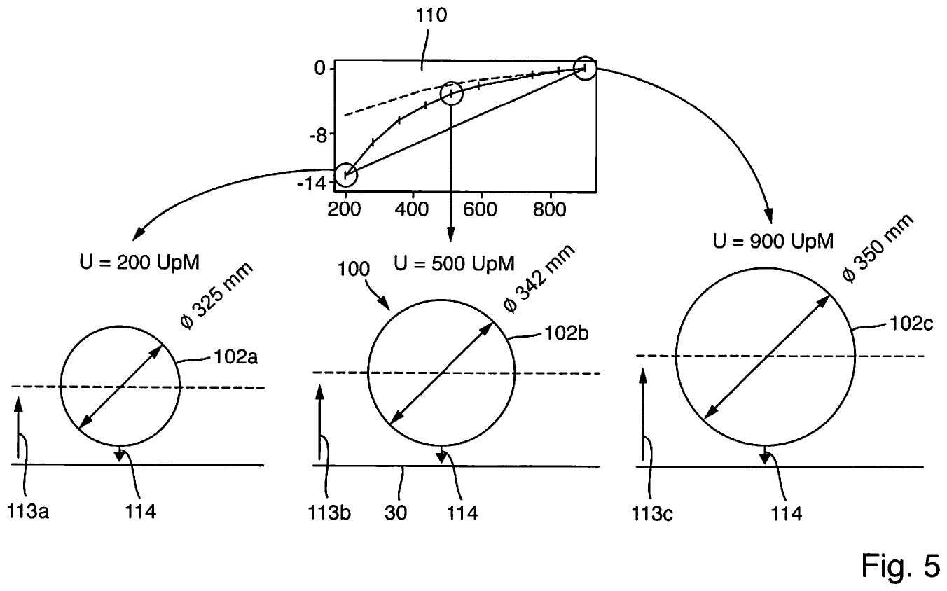

FIG. 5 the schematic calibration and adjustment of the machine;

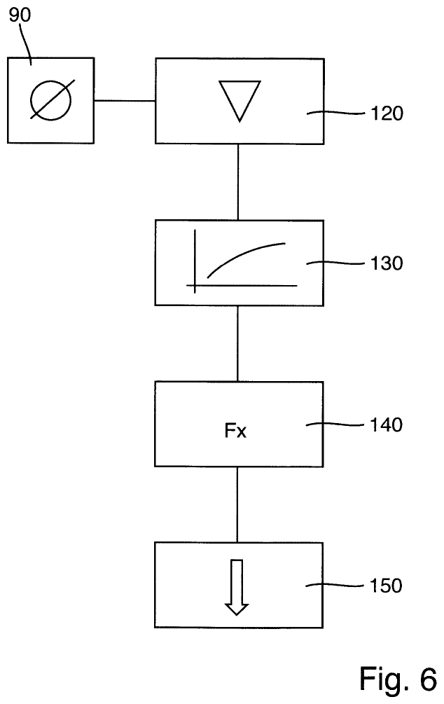

FIG. 6 a device for calibrating and adjusting the machine from FIG. 1;

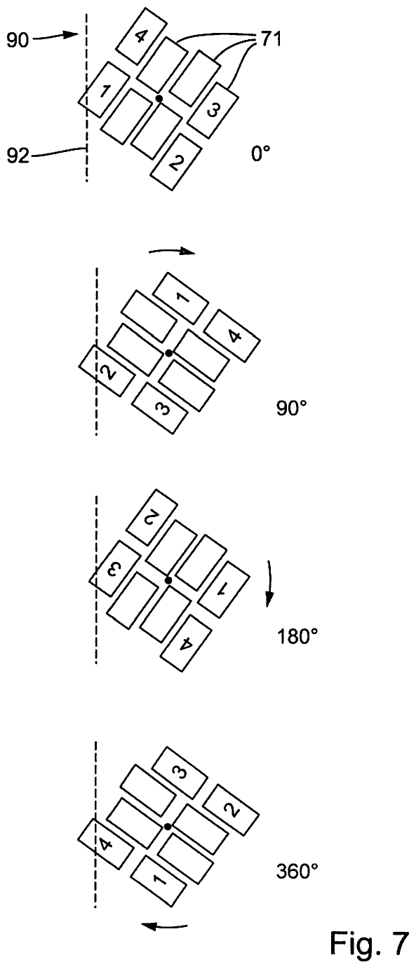

FIG. 7 a schematic rotation of the brush unit according to FIG. 2 through 360 degrees;

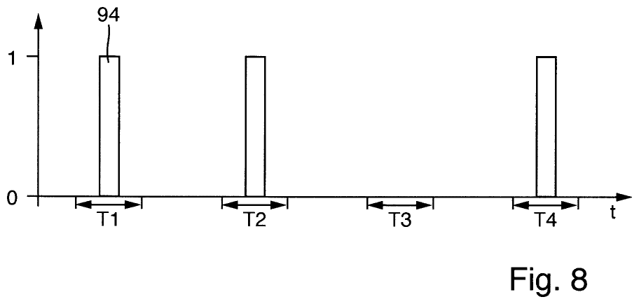

FIG. 8 the signal from the light barrier from FIG. 2.

The machine depicted in FIG. 1 functions here for processing relatively thick sheet metal parts 10, e.g., made of stainless steel.

A conveyor belt 30 is mounted in a machine frame 20 spaced apart from the floor. Conveyor belt 30 protrudes beyond machine frame 20 at the inlet and outlet of the machine, so that sheet metal part 10 may be placed on conveyor belt 30 at the inlet and unloaded at the outlet. Sheet metal part 10 to be processed is transported continuously through the machine by conveyor belt 30 in the direction of the arrow in order to successively pass through three different processing units.

The first processing unit is a first abrasive belt unit 40 with a coarse-grained abrasive belt that circulates endlessly. Abrasive belt unit 40 is seated in a first auxiliary frame 50, which includes an adjustment device in the form of a screw jack 60. The distance between conveyor belt 30 and abrasive belt unit 40 or the infeed may be adjusted very precisely and adapted if necessary.

The second processing unit is a brush unit 70. It is arranged downstream of first abrasive belt unit 40 in the throughput direction of sheet metal part 10 and represents the core of the machine.

Brush unit 70 has a total of eight abrasive brushes 71, four of which rotate in the running direction and four of which rotate in the opposite direction about horizontal axes. Only the front group of four abrasive brushes 71 may be seen in FIG. 1.

An electric drive unit 72 drives abrasive brushes 71 via a transfer case 73. Drive unit 72 is suspended in a fixed manner in machine frame 20, whereas transfer case 73 is rotatable about its vertical axis. A multi-rotational movement of abrasive brushes 71 results from this.

Abrasive brushes 71 are designed as cylindrical grinding drums or roller brushes and have a round cross section. Each abrasive brush 71 comprises a plurality of flexible abrasive strips 71a, which may comprise abrasive cloths, whose ends brush over the surface of sheet metal part 10 being guided under abrasive brushes 71, and thereby may penetrate a certain distance into recesses and may also grind over the outer edges of sheet metal part 10. By this means, the surface of sheet metal part 10 is brushed or ground and simultaneously both the front and the side edges are rounded.

Brush unit 70 has a device arranged between drive unit 72 and machine frame 20 for the vertical displacement of the entire brush unit 70. This height adjustment device is designed here as a screw jack 74a, 74b, for example. By this means, the processing gap or the infeed, that is, the distance between individual abrasive brushes 71 and the working strand of conveyor belt 30, may be set very precisely.

The third processing unit is a second abrasive belt unit 80 which is arranged downstream of central brush unit 70 in the throughput direction of sheet metal part 10. This second abrasive belt unit substantially corresponds to first abrasive belt unit 40, but is equipped with a much finer-grained abrasive belt and is used for finish grinding of the upper side of sheet metal part 10.

The enlarged depiction of one part of brush unit 70 in FIG. 2 makes the cylindrical or drum-shaped form of abrasive brushes 71 clear. Abrasive brushes 71 rotate at high speed around their horizontal axes. Flexible abrasive strips 71a of abrasive brushes 71 are slightly bent counter to the direction of rotation in the unloaded state and straighten out with increasing speed due to the centrifugal force and spread out from the core, whereby the diameter of freely rotating abrasive brush 71 increases.

A light barrier 90 is arranged below brush unit 70 and abrasive brushes 71. A transmitter 91 with a laser diode emits a laser beam 92 which is received by a receiver 93. Abrasive brushes 71 may be moved gradually downwards by means of jack screw 74a, 74b (cf. FIG. 1) until they interrupt laser beam 92.

FIG. 3 illustrates the measuring principle, wherein only one single abrasive brush 100 is depicted here for the sake of simplicity, which is representative for abrasive brushes 71 of brush unit 70 (cf. FIG. 1, FIG. 2).

Abrasive brush 100 has flexible bristles 101 protruding radially outwards, which comprise, for example, elastic wire or may be designed as abrasive strips, corresponding to abrasive strips 71a in FIG. 2.

Abrasive brush 100 rotates about a horizontal axis, which extends parallel to conveyor belt 30, and rotates freely, that is, without contacting a workpiece, at a first speed. Abrasive brush 100 is moved vertically downwards in the direction of the arrow until laser beam 92 of light barrier 90 is interrupted. A first diameter 102a may be determined from the known vertical positions of the laser beam and the center point of the axis of abrasive brush 100. If the speed is increased, flexible, elastic bristles 101 stand up due to the higher centrifugal forces, so that the diameter of abrasive brush 100 increases. Second diameter 102b results at this second speed. If bristles 101 are already worn and are therefore shorter than when they were new, this is automatically included in the measurement of diameters 102a and 102b. Finally, a third diameter 102c is detected at a third speed.

The result of the measurements may be gathered from the graph in FIG. 4. The rotor speed R is plotted on the x-axis, and the difference from the nominal diameter of abrasive brush 100 on the y-axis. The first (lower) curve depicts progression 111 for a first type of abrasive brush 100, the second (upper) curve shows progression 112 for a second type of abrasive brush 100. When changing tools, the stored values or curves may be accessed. Diameters or differences from the nominal diameter for speeds, which lie between the speeds at which the diameter was actually detected, may be interpolated.

The procedure for calibrating and setting up the machine is demonstrated by way of FIG. 5:

In the first step, three different diameters 102a, 102b, 102c of freely rotating abrasive brush 100 are detected at three different speeds of freely rotating abrasive brush 100. The respectively measured diameters 102a, 102b, 102c and the associated speeds are stored, as depicted in graph 110.

If abrasive brush 100 is now to run at a specific selected speed, the correct vertical position, that is, distance 113a, 113b, 113c between the axis of rotation of abrasive brush 100 and conveyor belt 30, on which sheet metal part 10 to be processed rests, may be calculated on the basis of the stored values for diameter and associated speed.

If a higher speed is selected, the adjustment of the processing gap or infeed is carried out using a second, larger diameter 102b or, at an even higher speed, using a third diameter 102c. In this way, not only is the increase in the diameter of abrasive brush 100 taken into account at higher rotational speeds, but also the wear, which leads to a gradual reduction in the diameter during the service life as a result of the shortening of bristles 101 or abrasive cloths 71e, is automatically taken into account. The result is a processing gap 114 that is always adjusted correctly, regardless of the variable speed-dependent diameter 102a, 102b or 102c of abrasive brush 100.

The device for calibrating and adjusting a sheet metal processing machine, for example, the machine according to FIG. 1, schematically depicted in FIG. 6, comprises an input interface 120 for receiving the measurement data from a measuring device, which detects the diameter of the freely rotating abrasive brush as different speeds. Light barrier 90 is an essential part of the measuring device. The diameters detected at different speeds are stored in a memory unit 130. A calibration device 140 functions to calculate the vertical position of the brush unit above the sheet metal part depending on a selected speed and the associated, stored diameter of the active abrasive brush. The result of the calibration is supplied to a control unit 150, which determines the vertical position of the brush unit relative to the conveyor belt or to the sheet metal part resting on the conveyor belt.

It will now be explained by way of FIG. 7 how the diameter of four abrasive brushes 71 of brush unit 70 may be measured at different speeds in a sheet metal processing machine according to FIGS. 1 and 2 by means of single light barrier 90.

All eight abrasive brushes 71 of brush unit 70 rotate about their horizontal axes, which lie in a plane parallel to conveyor belt 30 (cf. FIG. 1). Four abrasive brushes 71 may be detected at the corners by laser beam 92; these are numbered counterclockwise in FIG. 7 with 1, 2, 3 and 4. Brush unit 70, on which eight abrasive brushes 71 are seated, may be rotated clockwise about its vertical axis, as indicated by arrows.

The measurement or calibration starts with freely rotating abrasive brushes 71 at a first predetermined speed. At the same time, brush unit 70 rotates about its vertical axis. At a rotation angle of 0 degrees, as may be seen at the top in FIG. 7, stationary laser beam 92 may scan abrasive brushes 71 with numbers 1, 2, 3 and 4 in sequence. As soon as brush unit 70 or abrasive brushes 71 are lowered sufficiently in the vertical direction in relation to conveyor belt 30 or workpiece 10 placed thereon (cf. FIG. 1), first abrasive brush 71 interrupts laser beam 92. Over the course of the further rotation of brush unit 70, abrasive brushes 71 with numbers 2, 3 and 4 arrive successively into the field of view of laser beam 92.

As is clear from the last FIG. 8, each of four abrasive brushes 71 is assigned a time window T1, T2, T3, T4 at the four corners, in which time window the signal from light barrier 90 (FIG. 2, FIG. 7) is evaluated. The signal may only assume two values, namely the value ONE for the interruption of laser beam 92 and the value ZERO for uninterrupted laser beam 92, which is received by receiver 93 of light barrier 90 (cf. FIG. 2). In the example depicted, only abrasive brushes 70 with numbers 1, 2 and 4 lead to a signal with the value ONE in corresponding time windows T1, T2 and T4, which means that the instantaneous diameter of abrasive brush 71, which triggers the signal, may be determined from the associated vertical distance to conveyor belt 30.

If brush unit 70 is now lowered further while continuing to rotate about its vertical axis, the last of three abrasive brushes 71 with the number 3 (cf. FIG. 7) finally also triggers light barrier 90. Because all four abrasive brushes 71 successively interrupt laser beam 92 of light barrier 90, namely respectively within a defined time window, the diameters of individual abrasive brushes 71 may be respectively measured separately and used as the basis for calibrating and adjusting the machine.

### LIST OF REFERENCE NUMERALS

10 Sheet metal part
20 Machine frame
30 Conveyor belt
40 First abrasive belt unit
50 Subframes (of 40)
60 Screw jack
70 Brush unit
71 Abrasive brushes
71a Abrasive strips (of 71)
72 Drive unit
73 Transfer case
74a, 74b Screw jack (for 70)
80 Second abrasive belt unit
90 Light barrier
91 Transmitter
92 Laser beam
93 Receiver
94 Signal
100 Abrasive brush
101 Bristles (of 100)
102a, 102b, 102c Diameter (of 100)
110 Graph
111 First progression
112 Second progression
113a, 113b, 113c Distance
114 Processing gap
120 Input interface
130 Memory unit
140 Calibration device
150 Control unit

1. A machine for processing sheet metal parts, comprising:
a brush unit with at least one horizontally rotating abrasive brush for brushing the surface of the sheet metal parts to be processed;
a device for vertically moving the brush unit in order to adjust the processing gap;
a measuring device for detecting the diameter of the freely rotating abrasive brush at different speeds;
a calibration device for calculating the correct vertical position of the abrasive brush depending on a selected speed and the associated diameter of the abrasive brush.

2. The machine according to claim 1, wherein the measuring device is an optical measuring unit for scanning the diameter of the abrasive brush without contact.

3. The machine according to claim 1, wherein the measuring device is a light barrier which is interrupted by the abrasive brush when the brush unit is lowered.

4. The machine according to claim 1, wherein the brush unit is rotatable about its vertical axis and has at least four horizontally rotating abrasive brushes which interrupt the light barrier during one complete rotation of the brush unit.

5. A method for calibrating and adjusting a machine for processing sheet metal parts comprising a brush unit with at least one horizontally rotating abrasive brush for brushing the surface of the sheet metal part to be processed and a device for vertically moving the brush unit, comprising the steps:
detecting the diameter of the freely rotating abrasive brush at different speeds;
calculating the correct vertical position of the abrasive brush depending on a selected speed and the associated diameter;
vertically moving the brush unit until it reaches the calculated position above the sheet metal part.

6. The method according to claim 5, wherein the respectively measured diameter measured and the associated speeds are stored.

7. The method according to claim 5, wherein the diameter of the abrasive brush is detected for at least three different speeds.

8. A device for calibrating and adjusting a sheet metal processing machine comprising a brush unit with at least one rotating abrasive brush for brushing the surface of a sheet metal part to be processed and a device for vertically moving the brush unit in order to adjust the processing gap, comprising:
an input interface for receiving measurement data of a measuring device, which detects the diameter of the freely rotating abrasive brush at different speeds;
a memory unit for storing the detected diameters and the associated speeds;
a calibration device for calculating the vertical position of the brush unit relative to the sheet metal part depending on a selected speed and the associated, stored diameter of the abrasive brush.

9. The device according to claim 8, wherein the measurement data received by the input interface comprises the diameters for at least three different speeds.

10. Computer program product comprising program code for carrying out the steps of the method of claim 5 when the program code is executed on a computer.
